(19) United States
(12) Patent Application Publication
(10) Pub. No.: US 2022/0360875 A1
(43) Pub. Date: Nov. 10, 2022

(54) Earphone

(71) Applicant: Yamaha Corporation, Hamamatsu-shi (JP)

(72) Inventors: Yasuaki TAKANO, Kikugawa-shi (JP); Hiroyuki AYAME, Hamamatsu-shi (JP); Tomoaki MORI, Hamamatsu-shi (JP); Katsuya UCHIDA, Iwata-shi (JP)

(21) Appl. No.: 17/739,975

(22) Filed: May 9, 2022

(30) Foreign Application Priority Data
May 10, 2021 (JP) 2021-079498

(51) Int. Cl. H04R 1/08; H04R 1/10; H04R 1/02

(52) U.S. Cl. CPC H04R 1/08; H04R 1/1016; H04R 1/02

(57) ABSTRACT

An earphone includes a housing and a microphone. The microphone is provided in the housing. The housing includes a hole that leads to the microphone. The hole has a shape in which a cross-sectional area expands, toward a back of a head of a user wearing the earphone, from the microphone toward an outside of the housing. The housing, in a case of being worn by the user, is located farther away from an external earhole, in an outside direction from a side of the head, than from an ear of the user.

### CROSS REFERENCE TO RELATED APPLICATIONS

This application claims priority under 35 U.S.C. § 119(a) on Patent Application No. 2021-079498 filed in Japan on May 10, 2021, the entire contents of which are hereby incorporated by reference.

### BACKGROUND

An embodiment of the present disclosure relates to an earphone used by being inserted into an ear canal of a user.

Japanese Unexamined Patent Application Publication No. 2010-157787 discloses an earphone with a structure in which a housing is made thinner to reduce wind blowing in a direction from the back of the head to the front of the head by an auricle E2 and prevent wind blowing in a direction from the front of the head to the back of the head by an inner wall E4a of a helix E4.

The structure of Japanese Unexamined Patent Application Publication No. 2010-157787 is unable to reduce noise in a case in which a main body of the earphone protrudes more outward than the ear of a wearer.

### SUMMARY

In view of the foregoing, an embodiment of the present disclosure is directed to provide an earphone capable of reducing noise even in a case in which a main body protrudes more outward than an ear.

An earphone includes a housing and a microphone provided in the housing. The housing includes a hole that leads to the microphone, the hole has a shape of which a cross-sectional area expands in a direction of a back of a head in a posture of a user in wearing from the microphone toward an outside of the housing, and the housing, in a case of being worn by the user, is located farther away from an external earhole in an outside direction from a side of the head than from an ear of the user.

According to an embodiment of the present disclosure, noise is able to be reduced even in a case in which a main body protrudes more outward than an ear.

### BRIEF DESCRIPTION OF THE DRAWINGS

FIG. 1 is a view showing a state in which an earphone 1 is worn in an ear;

FIG. 2A is a front view of the earphone 1;

FIG. 2B is a rear view of the earphone 1;

FIG. 3A is a right side view of the earphone 1;

FIG. 3B is a left side view of the earphone 1;

FIG. 4A is a top view of the earphone 1;

FIG. 4B is a bottom view of the earphone 1;

FIG. 5 is a perspective view of the earphone 1 viewed from an upper left side;

FIG. 6 is a schematic cross-sectional diagram showing a portion of a hole 15;

FIG. 7 is a schematic cross-sectional diagram of a main body 10;

FIG. 8 is a perspective view of an earphone 1;

FIG. 9 is a schematic cross-sectional diagram showing a portion of a hole 15;

FIG. 10 is a schematic cross-sectional diagram showing a modification of a portion of which a cross-sectional area expands;

FIG. 11 is a schematic cross-sectional diagram showing a case in which a wire net 71 is provided; and

FIG. 12 is a schematic cross-sectional diagram showing a case in which a mesh 72 is further provided.

### DETAILED DESCRIPTION

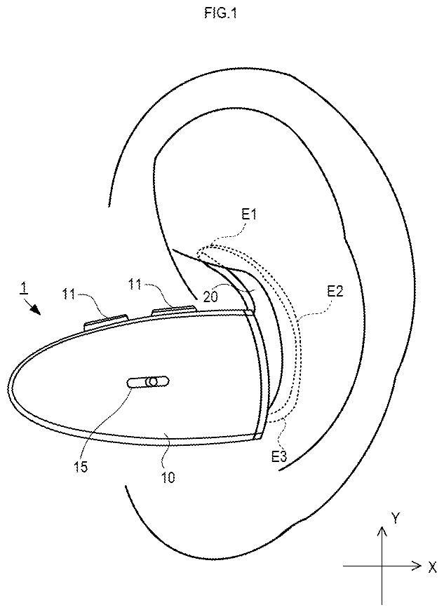

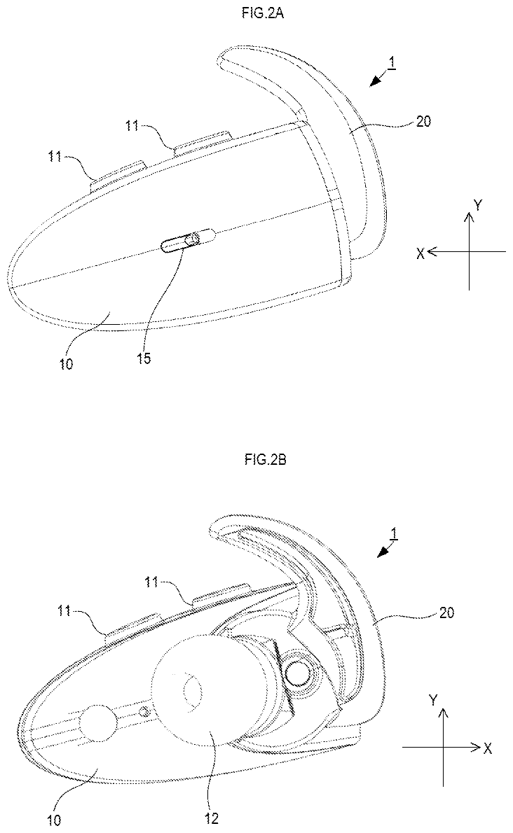

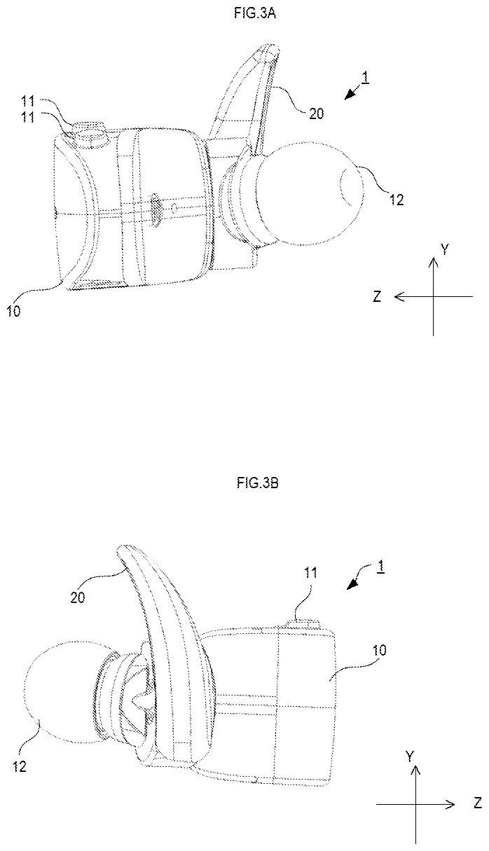

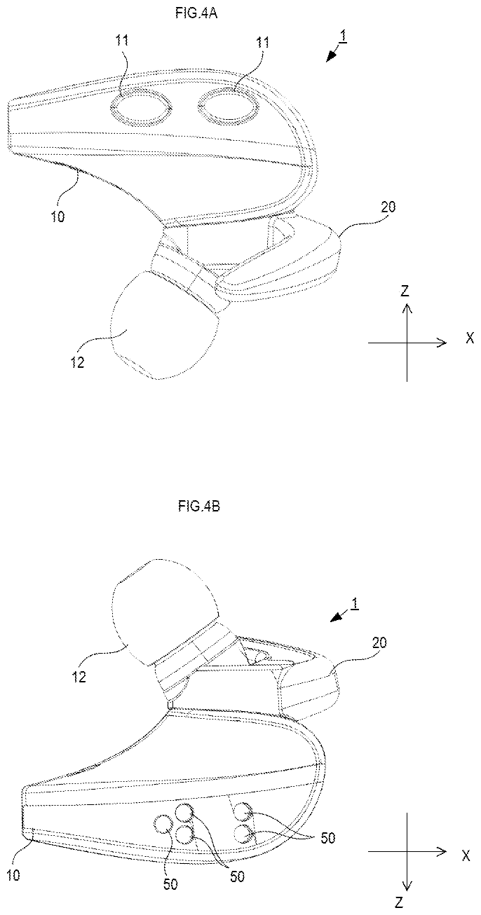

FIG. 1 is a view showing a state in which an earphone 1 is worn in an ear. FIG. 2A is a front view of the earphone 1. FIG. 2B is a rear view of the earphone 1. FIG. 3A is a right side view of the earphone 1. FIG. 3B is a left side view of the earphone 1. FIG. 4A is a top view of the earphone 1. FIG. 4B is a bottom view of the earphone 1. It is to be noted that, in the drawings, a front direction, a top direction, and a left side direction are respectively referred to as an X direction, a Y direction, and a Z direction.

The earphone 1 receives an audio signal through wireless communication such as Bluetooth (registered trademark), from an information processing terminal such as a smartphone, or a player such as a portable music reproduction apparatus. However, the present disclosure is not limited to an earphone for wireless communication. The earphone may be connected to the player with a cable.

The earphone 1 includes two units of a unit used by being inserted into a left ear and a unit used by being inserted into a right ear. The right and left units are not connected with a cable or the like. In other words, the earphone 1 is a true wireless earphone including right and left independent units. However, the present disclosure does not need to be right and left independent units. The right and left independent units may be connected with a cable.

It is to be noted that, while the present embodiment describes a unit used by being inserted into a left ear, a unit used by being inserted into a right ear also has the same configuration and function.

The earphone 1 includes a main body (a housing) 10, a button 11, an insert portion 12, a hole 15, and a holding member 20.

The earphone 1 is used by being inserted into an ear canal. The main body 10 includes a driver unit, a battery, a microphone, and similar components. A length (a thickness) in the left side direction of the main body 10 is small, and a length (a height) in the Y direction and a length (a depth) in the X direction are larger than the thickness.

In addition, the depth of the main body 10 is larger than the height. The rear side of the main body 10 is almost linear, when viewed from a right side. The front side of the main body 10 is gradually reduced in height in the front direction, and a tip of the front side is narrowed into an arc-like shape. The left side of the main body 10 is almost planar and is inclined to the right side in the rear direction. The hole 15 is provided at almost the center position of a left side surface of the main body 10. The hole 15 acoustically opens a sound collecting surface of the microphone that is built into the main body 10.

It is to be noted that the shape of the main body 10 shown in the present embodiment is an example, and the shape of the main body of the present disclosure is not limited to the example shown in the present embodiment.

The button 11 is disposed on an upper side of the main body 10. The button 11 may include a volume UP button and a volume DOWN button, for example. A charging terminal 50 to charge a battery is provided on a lower side of the main body 10.

The insert portion 12 is disposed on the right side of the main body 10. A right side surface of the main body 10 expands into a cylindrical shape in a portion into which the driver unit is built. The insert portion 12 is disposed so as to protrude in the right side direction from the portion that expands into the cylindrical shape. The main body 10, in a case of being worn by the user, is located farther away from an external earhole in an outside direction from a side of the head than from an ear of the user.

The insert portion 12 is inserted into the ear canal of a user. The insert portion 12 is covered by an earpiece. The earpiece may be made of a resin with high flexibility, such as silicone rubber, polyurethane, or epoxy, for example. The earpiece may be integrated with the insert portion 12 or may be attachable to and detachable from the insert portion 12. In a case in which the earpiece is attachable to and detachable from the insert portion 12, a plurality of types of earpieces of different sizes may be prepared. In such a case, the user can select an earpiece of a suitable size according to the size of the ear.

The holding member 20 is disposed between the main body 10 and the insert portion 12. The holding member 20 is attached to the main body 10 through a cylindrically expanded portion of the main body 10, the part including the built-in driver unit. The holding member 20 is fitted into a concha of a user. The earphone 1 is able to achieve very high adhesion by the holding member 20.

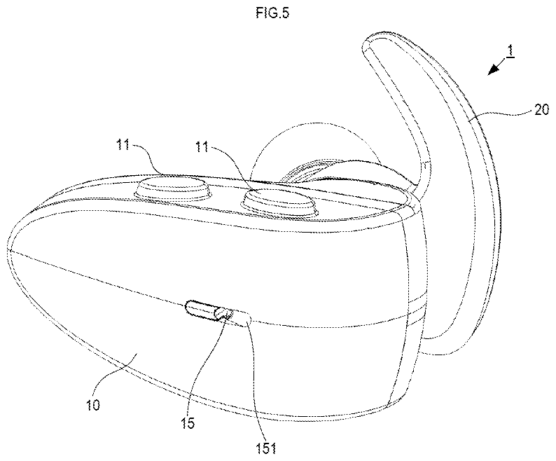

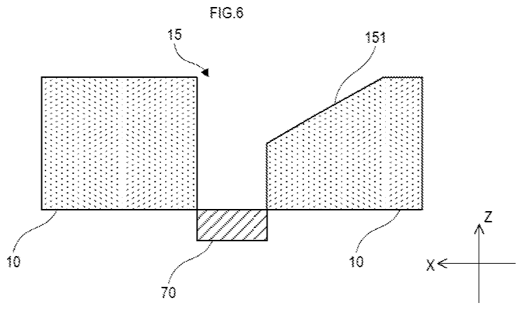

FIG. 5 is a perspective view of the earphone 1 viewed from an upper left side. FIG. 6 is a schematic cross-sectional diagram showing a portion of the hole 15.

The hole 15 leads to the microphone 70. The hole 15 has a shape of which a cross-sectional area expands in a direction of a back of a head in a posture of the user in wearing from the microphone toward an outside of the main body 10. In the example shown in FIG. 5 and FIG. 6, the hole 15 has a tapered portion 151 that extends in the direction of the back of the head.

As the user moves forward (in the X direction), a flow of air is generated in a direction from the front of the head toward the back of the head. Herein, the air flowing through the sides of the main body 10 may be disturbed at a position of a front end of the hole 15. However, at the hole 15, the tapered portion 151 is located in the direction of the back of the head, and the cross-sectional area expands. Therefore, even when a turbulent flow is generated at the position of the front end of the hole 15, the tapered portion 151 greatly reduces the velocity of air flowing in the direction of the back of the head and the air flows in the direction of the back of the head. Therefore, wind noise due to the turbulent flow is not collected by the microphone 70 at a high level. As a result, the earphone 1 reduces the wind noise due to a turbulent flow from being collected by the microphone 70 at a high level, even when the flow of fast air is generated in the direction from the front of the head to the back of the head, for example, by intense movement such as sports.

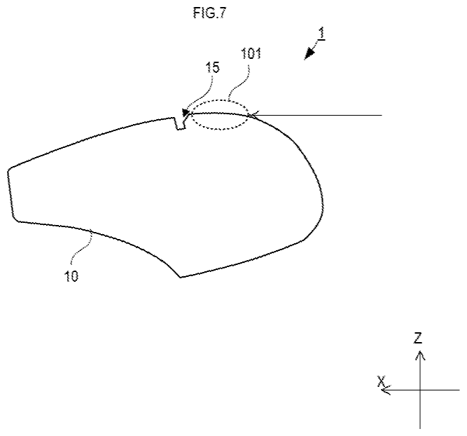

FIG. 7 is a partial schematic cross-sectional diagram of the main body 10. FIG. 7 is a view obtained by extracting only a portion of the main body 10 from the top view of FIG. 4A. As shown in FIG. 7, the main body 10 has an expansion portion 101 that expands in the direction (the Z direction) of the side of the head, in the direction of the back of the head, in a case of being worn in an ear. As shown by a straight arrow in FIG. 7, air assumingly flows in the direction (the X direction) from the back of the head toward the front of the head, the air hit the expansion portion 101. Therefore, the wind noise does not enter the hole 15 and is reduced from being collected by the microphone 70 at a high level.

As described above, the hole 15 of the earphone 1 according to the present embodiment has a shape of which the cross-sectional area expands in the direction of the back of the head in the posture of the user in wearing, so that even an earphone with a structure in which the main body 10 protrudes more outward than an ear is also able to reduce noise.

In the present embodiment, the portion of which the cross-sectional area expands is provided only in the direction of the back of the head. However, the portion of which the cross-sectional area expands may be provided in a direction other than the direction of the back of the head.

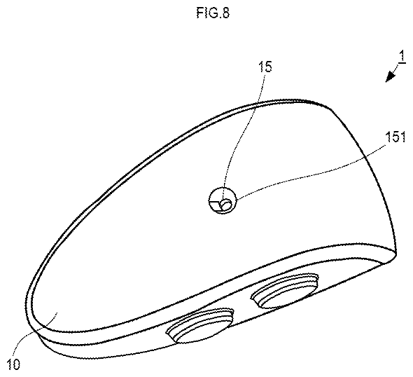

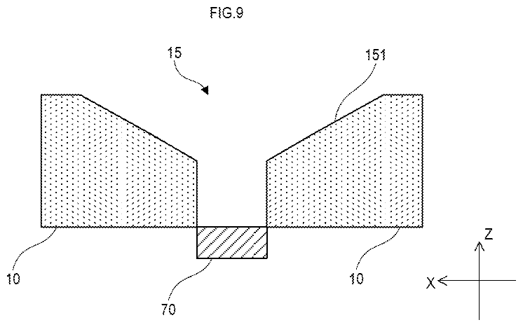

FIG. 8 is a perspective view of an earphone 1 including a portion of which the cross-sectional area expands according to a first modification. FIG. 9 is a schematic cross-sectional diagram showing a portion of a hole 15 according to the first modification. As shown in FIG. 8 and FIG. 9, the portion of which the cross-sectional area expands may have a circular truncated cone shape. In such a case, even when air flows in any direction, the wind noise due to a turbulent flow is able to be reduced.

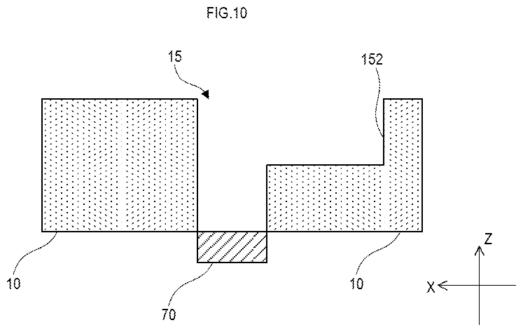

In addition, the portion of which the cross-sectional area expands is not limited to be tapered in shape. FIG. 10 is a schematic cross-sectional diagram of an earphone 1 including a portion of which the cross-sectional area expands according to a second modification. The portion of which the cross-sectional area expands, as shown in the schematic cross-sectional diagram of FIG. 10, for example, may be a level difference 152 of which a cross-sectional area expands so as to have a difference in level. Even in such a case, the air flowing in the direction of the front of the head flows in the direction of the back of the head with a greatly reduced velocity due to the level difference 152 of which the cross-sectional area expands. Therefore, the wind noise due to the turbulent flow is not collected by the microphone 70 at a high level.

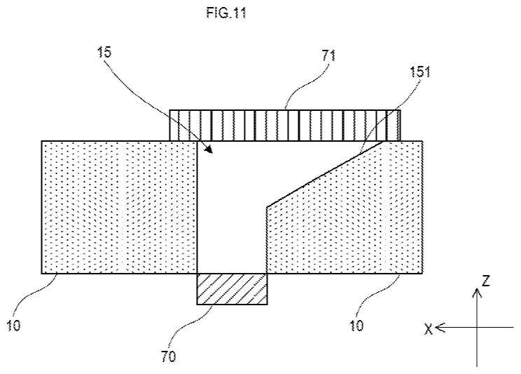

Subsequently, FIG. 11 is a schematic cross-sectional diagram showing an earphone 1 including a wire net 71. The same reference numerals are used to refer to components common to FIG. 6, and the description will be omitted. The wire net 71 is provided on the surface of the main body 10, at the hole 15. The wire net 71 is made of braided metal wires, for example. The wire net 71 reduces the flow of air with a high velocity from entering the inside of the hole 15. As a result, the earphone 1 further reduces the wind noise due to a turbulent flow from being collected by the microphone 70 at a high level.

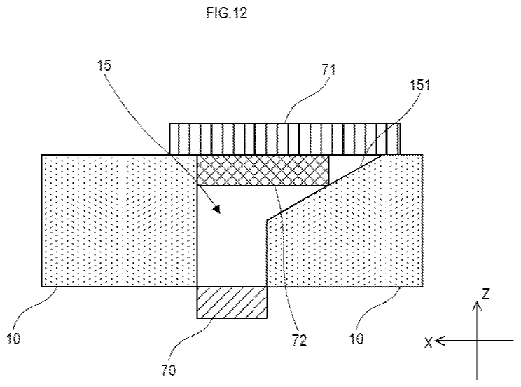

FIG. 12 is a schematic cross-sectional diagram showing an earphone 1 further including a mesh 72. The same reference numerals are used to refer to components common to FIG. 11, and the description will be omitted. The mesh 72 is provided inside the main body 10, at the hole 15. The mesh 72 is made of foamed rubber, for example. The mesh 72 also reduces the flow of air with a high velocity from entering the inside of the hole 15. As a result, the earphone 1 further reduces the wind noise due to a turbulent flow from being collected by the microphone 70 at a high level. It is to be noted that, while FIG. 12 shows a configuration including both the wire net 71 and the mesh 72, the earphone 1 may include only the mesh 72.

The description of the foregoing embodiments is illustrative in all points and should not be construed to limit the present disclosure. The scope of the present disclosure is defined not by the foregoing embodiments but by the following claims for patent. Further, the scope of the present disclosure is intended to include all modifications within the scopes of the claims for patent and within the meanings and scopes of equivalents.

What is claimed is:

1. An earphone comprising:
a housing; and
a microphone provided in the housing, wherein:
the housing includes a hole that leads to the microphone;
the hole has a shape in which a cross-sectional area expands, toward a back of a head of a user wearing the earphone, from the microphone toward an outside of the housing; and
the housing, in a case of being worn by the user, is located farther away from an external earhole, in an outside direction from a side of the head, than from an ear of the user.

2. The earphone according to claim 1, wherein the housing includes a portion that expands in a direction of the side of the head, and in a direction of the back of the head, in a case of being worn in the ear.

3. The earphone according to claim 1, wherein the shape of which the cross-sectional area expands is provided only in the direction of the back of the head.

4. The earphone according to claim 1, wherein a mesh is provided inside the housing, at the hole.

5. The earphone according to claim 4, wherein the mesh is made of foamed rubber.

6. The earphone according to claim 1, wherein a wire net is provided on a surface of the housing, at the hole.

7. The earphone according to claim 6, wherein the wire net is made of braided metal wires.

8. The earphone according to claim 1, wherein, in a case of being worn in the ear of the user, the housing partially protrudes outwardly more than the ear of the user.

9. The earphone according to claim 1, wherein the shape of which the cross-sectional area expands is a tapered shape.

10. The earphone according to claim 1, wherein an audio signal is received through wireless communication.

11. The earphone according to claim 10, further comprising: an independent left unit and right unit that are insertable, respectively, into a left ear and right ear of the user.
